(19) United States
(12) Patent Application Publication
(10) Pub. No.: US 2017/0056779 A1
(43) Pub. Date: Mar. 2, 2017

(54) AIR FLOW SWITCHING APPARATUS WITH SIX-WAY VALVE FOR INFLATABLE TOY

(71) Applicant: GEMMY INDUSTRIES CORPORATION, Coppell, TX (US)

(72) Inventor: Cheng-Chun ZHANG, Shenzhen City (CN)

(21) Appl. No.: 14/840,999

(22) Filed: Aug. 31, 2015

(51) Int. Cl. A63H 3/06; F16K 11/02

(52) U.S. Cl. CPC A63H 3/06; F16K 11/02

(57) ABSTRACT

An air flow switching apparatus includes a six-way valve, a Geneva mechanism, and a driving motor. The six-way valve includes an inlet, an outlet and four openings. The driving motor with the Genera mechanism connected with the valve vane and the air flow switching apparatus is installed within an inflatable toy. The four openings of the six-way valve are respectively connected with four airbags at a periphery of the inflatable toy and the airbags are used as limbs of the inflatable toy. When the air pump pumps air into a body, a portion of the air passes through the six-way valve into some airbags and a portion of the air is released from some airbags. The driving motor drives the valve vane to intermittently rotate via the Geneva mechanism. Therefore, the limbs generate different motions by the air to let the inflatable toy have vivid motion effect.

### BACKGROUND OF THE INVENTION

1. Field of the Invention

The present invention relates to a switching apparatus used in an inflatable toy and more particularly relates to a switching apparatus with six-way valve capable of driving the inflatable toy's limbs to motion.

2. Description of the Related Art

Inflatable toys are usually decorated and presented at various exhibitions, fairs and dance venues and are displayable and entertaining. A structure of a conventional inflatable toy includes a hollow body and an air pump mounted on a bottom of the toy body. While the toy is inflated by the air pump, the inflatable toy is expanded in volume into a fixed form for entertainment, advertisement and decoration purposes.

The conventional inflatable toy can be only statically exhibited on the ground without vivid motion and easily become stereotypical in terms of visual perception with less entertaining and decorating effect. Therefore, someone has designed an inflatable toy including different motions. The inflatable toy is implemented with a valve assembly inside a toy body to vary air flow direction so as to let the inflatable toy have swinging motion.

However, the aforementioned inflatable toy can only perform some easy and simple motions. Since the motions of the inflatable toy have less variability, the entertainment and the fun of the inflatable toy is poor and the current usage requirement is not satisfied.

### SUMMARY OF THE INVENTION

An objective of the present invention is to provide an air flow switching apparatus with six-way valve used in an inflatable toy to overcome shortcomings of simple motions with less variability and demonstrate a more animated visual effects arising from a constantly changing waving direction of the toy.

To achieve the foregoing objective, the air flow switching apparatus with six-way valve is provided and includes:

a six-way valve including:
a valve housing having:
   an alignment chamber in a circular shape;
   an inlet and an outlet disposed at two sides of the alignment chamber along a radial direction of the alignment chamber and opposite to each other;
   a first opening, a second opening, a third opening, a fourth opening, the inlet, and the outlet disposed at a periphery of the valve housing at equiangular intervals and connected with the alignment chamber respectively;
the first opening and the second opening disposed at one side of a centre line from the inlet to the outlet;
the third opening and the fourth opening disposed at the other side of the centre line from the inlet to the outlet; and
a valve vane having:
   a length corresponding to a diameter of the alignment chamber; and
   a pivot at a middle of the valve vane,
   wherein the valve vane is rotatably and pivotally disposed within the alignment chamber and is rotated to switch positions within the alignment chamber to respectively vary a connection relationship of the inlet and the outlet with the first opening, the second opening, the third opening, and the fourth opening;

a Geneva mechanism including:
a driving wheel having:
   a circular wheel body;
   an axle portion disposed at a centre of the circular wheel body;
   an arced notch disposed at one side of the circular wheel body;
   a cam portion formed at one end surface of the driving wheel along an axial direction of the driving wheel and radially protruding to the arced notch; and
   a guiding rod in a circular shape disposed on the cam portion and at a position where a distance from the cam portion to the axle portion is greater than a radius of the circular wheel body; and
a Geneva wheel disposed outside of the valve housing of the six-way valve and having:
   a core wheel portion connected with the pivot of the valve vane;
   six guiding units disposed at a periphery of the core wheel portion at equiangular intervals;
   six concave arc portions each formed at an exterior edge of a respective one of the six guiding units, respectively corresponding to an exterior contour of the circular wheel body, and selectively sliding to contact the circular wheel body of the driving wheel; and
   six guiding grooves respectively disposed along a radial direction between every two of the adjacent guiding units and configured to be selectively inserted by the guiding rod of the driving wheel; and

a driving motor disposed outside of the valve housing of the six-way valve and having:
a shaft connected with the axle portion of the driving wheel of the Geneva mechanism;

wherein the driving motor drives the valve vane of the six-way valve to intermittently rotate via the Geneva mechanism.

In the aforementioned air flow switching apparatus with six-way valve, the valve housing of the six-way valve comprises two half portions and the two half portions of the valve housing are fastened to each other.

In the aforementioned air flow switching apparatus with six-way valve, the driving motor is disposed outside of the valve housing of the six-way valve via an exterior protective shell, and the exterior protective shell includes a shell base fixed at an exterior surface of the valve housing, the Geneva mechanism disposed within the shell base, and the driving motor disposed at an exterior surface of the shell base; a fixing base; and a cover fixing the shell base with the fixing base and the driving motor disposed within the cover and the shaft of the driving motor passing through the shell base to be connected with the axle portion of the driving wheel of the Geneva mechanism.

The advantages of the present invention is that the air flow switching apparatus with six-way valve is installed within the inflatable toy and the inlet of the six-way valve in the air flow switching apparatus with the six-way valve is connected with the exterior end of the air pump disposed at bottom of the inflatable toy. The outlet of the six-way valve is connected with the body of the inflatable toy. The first opening, the second opening, the third opening, and the fourth opening in the six-way valve are respectively connected with the four airbags at the periphery of the body. The airbags are used as movable limbs of the inflatable toy. Therefore, the air pump inputs air into the body of the inflatable toy and a portion of the air can pass through the six-way valve to pump air in a portion of the airbags at the periphery of the body and the air can be released from the rest of the airbags. Therefore, the driving motor with the Geneva mechanism drives the valve vane within the six-way valve to rotate intermittently so as to change air flow direction. The multiple movable limbs of the inflatable toy can include many different motions by alternate variation of air pumping and air exhausting, so the inflatable toy can have vivid motion effect.

### BRIEF DESCRIPTION OF THE DRAWINGS

FIG. 1 is a perspective view of an air flow switching apparatus with six-way valve used in an inflatable toy in the present invention;

FIG. 2 is an exploded perspective view of the air flow switching apparatus with six-way valve in FIG. 1;

FIG. 3 is a bottom view of a six-way valve and a Geneva mechanism in the air flow switching apparatus shown in FIG. 2;

FIG. 4 is a usage status view (I) showing that a portion of limbs of the inflatable toy is motioning by controlling air flow direction via the air flow switching apparatus with six-way valve in FIG. 1 and FIG. 2;

FIG. 5 is a schematic view of the air flow switching apparatus with six-way valve shown in FIG. 4;

FIG. 6 is a usage status view (II) showing that a portion of limbs of the inflatable toy is acting by controlling air flow direction via the air flow switching apparatus with six-way valve in FIG. 1 and FIG. 2;

FIG. 7 is a schematic view of the air flow switching apparatus with six-way valve shown in FIG. 6;

FIG. 8 is a usage status view (III) showing that a portion of limbs of the inflatable toy is motioning by controlling air flow direction via the air flow switching apparatus with six-way valve in FIG. 1 and FIG. 2; and

FIG. 9 is a schematic view of the air flow switching apparatus with six-way valve shown in FIG. 8.

### DETAILED DESCRIPTION OF THE INVENTION

These and other aspects of the embodiments herein will be better appreciated and understood when considered in conjunction with the following description and the accompanying drawings.

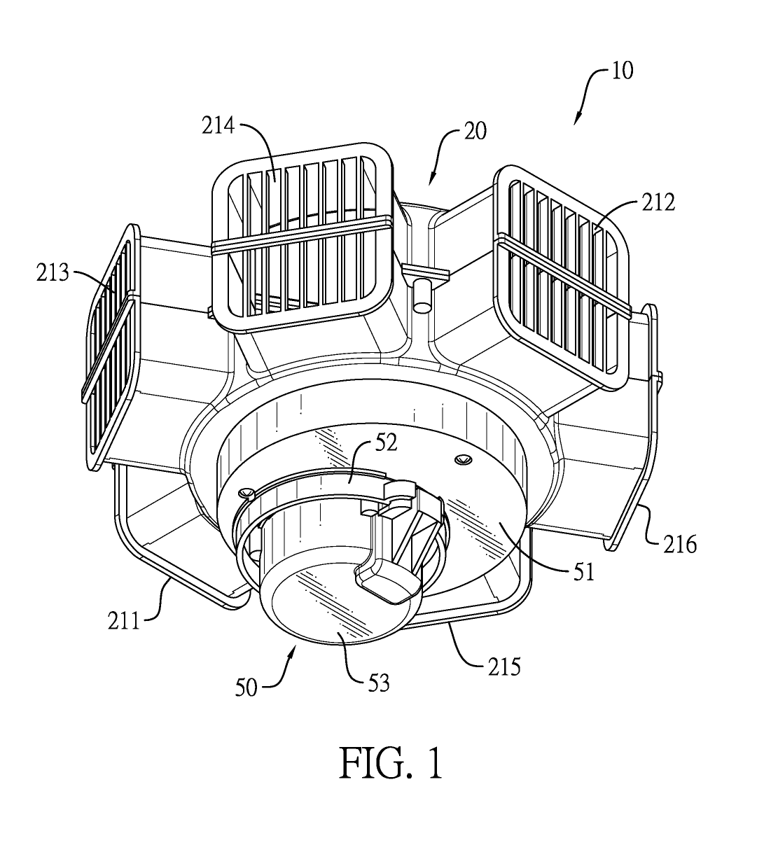

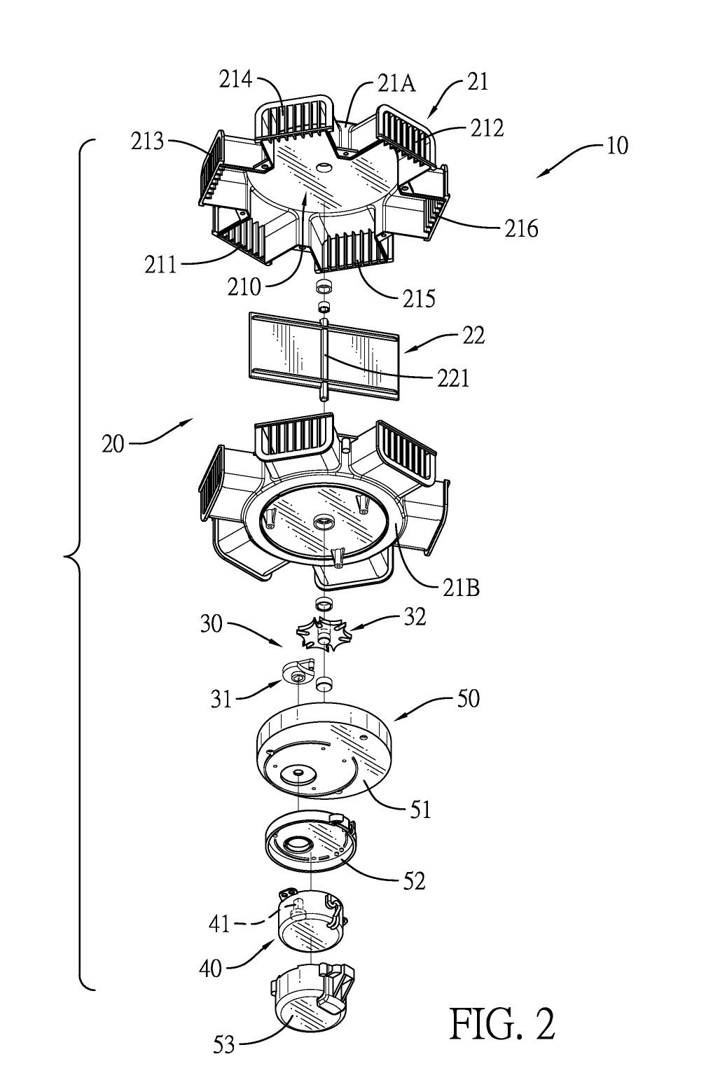

With reference to FIG. 1 and FIG. 2, an air flow switching apparatus 10 with six-way valve is disclosed in a preferred embodiment of the present invention. The air flow switching apparatus 10 with six-way valve includes a six-way valve 20, a Geneva mechanism 30 and a driving motor 40.

With reference to FIG. 1-FIG. 3, the six-way valve 20 includes a valve housing 21 and a valve vane 22. The valve housing 21 comprises two half portions 21A, 21B, and the two half portions 21A, 21B of the valve housing 21 are fastened together from top and bottom. The valve housing 21 includes an alignment chamber 210 in a circular shape, an inlet 211, an outlet 212, a first opening 213, a second opening 214, a third opening 215 and a fourth opening 216. The alignment chamber 210 is disposed at a center of the valve housing 21 and within the valve housing 21. The inlet 211, the outlet 212, the first opening 213, the second opening 214, the third opening 215 and the fourth opening 216 are disposed at a periphery of the valve housing 21 at equiangular intervals and respectively connected with the alignment chamber 210. The inlet 211 and the outlet 212 are at two sides of the alignment chamber 210 along a radial direction of the alignment chamber 210 and opposite to each other. The first opening 213 and the second opening 214 are disposed at one side of a centre line 23 from the inlet 211 to the outlet 212. The third opening 215 and the fourth opening 216 are disposed at the other side of the centre line 23 from the inlet 211 to the outlet 212. The valve vane 22 includes a pivot 221 disposed at a middle of the valve vane 22. The valve vane 22 is rotatably and pivotally disposed within the alignment chamber 210. A top end and a bottom end of the pivot 221 are respectively and pivotally connected with the top and the bottom half portions 21A, 21B of the valve housing 21. A length of the valve vane 22 is corresponding to a diameter of the alignment chamber 210. The valve vane 22 is rotated to switch positions within the alignment chamber 210 to vary a connection relationship of the inlet 211 and the outlet 212 with the first opening 213, the second opening 214, the third opening 215 and the fourth opening 216.

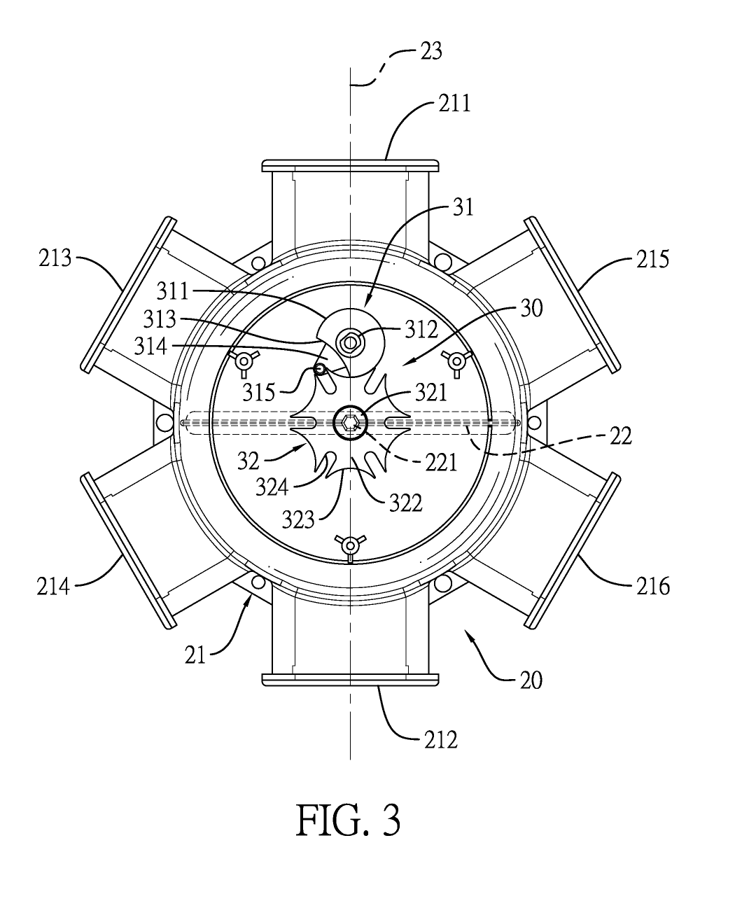

With reference to FIG. 2 and FIG. 3, the Geneva mechanism 30 is a mechanism capable of intermittently rotating. The Geneva mechanism 30 includes a driving wheel 31 and a Geneva wheel 32. The driving wheel 31 includes a circular wheel body 311, an axle portion 312, an arced notch 313, a cam portion 314, and a guiding rod 315. The axle portion 312 is formed at a centre of the circular wheel body 311 and the arced notch 313 is formed at one side of the circular wheel body 311. The cam portion 314 is formed on one end surface of the driving wheel 31 along an axial direction of the driving wheel 31 and protrudes from the arced notch 313 along a radial direction of the driving wheel 31. The guiding rod 315 in a circular shape is disposed on the cam portion 314 at a position where a distance from the cam portion 314 to the corresponding axle portion 312 is greater than a radius of the circular wheel body 311.

The Geneva wheel 32 includes a core wheel portion 321, six guiding units 322, six concave arc portions 323 and six guiding grooves 324. The six guiding units 322 are disposed at a periphery of the core wheel portion 321 at equiangular intervals. Each one of the concave arc portions 323 is respectively formed at an exterior edge of a respective one of the guiding units 322 and is corresponding to an exterior contour of the circular wheel body 311. Each of the guiding grooves 324 is respectively and radially disposed between every two of the adjacent guiding units 322, and the guiding rod 315 of the driving wheel 31 can be selectively inserted in the guiding groove 324. The concave arc portions 323 selectively slide to contact the circular wheel body 311 of the driving wheel 31. The Geneva mechanism 30 is disposed outside of the valve housing 21 of the six-way valve 20 and the core wheel portion 321 of the Geneva wheel 32 is connected with the pivot 221 of the valve vane 22.

The driving motor 40 is disposed outside of the valve housing 21 of the six-way valve 20 and includes a shaft 41. The shaft 41 is connected with the axle portion 312 of the driving wheel 31 of the Geneva mechanism 30, so the driving motor 40 can drive the valve vane 22 of the six-way valve 20 to intermittently rotate via the Geneva mechanism 30. The valve vane 22 is driven to rotate 60 degrees at each time.

With reference to FIG. 1 and FIG. 2, in the preferred embodiment, the driving motor 40 can be installed at bottom of the bottom half portion 21B of the valve housing 21 in the six-way valve 20 with an exterior protective shell 50. The exterior protective shell 50 includes a shell base 51, a fixing base 52 and a cover 53. The shell base 51 is fixed at bottom of the bottom half portion 21B of the valve housing 21, and the Geneva mechanism 30 is disposed within the shell base 51. The driving motor 40 is disposed at bottom surface of the shell base 51. The cover 53 is connected to the shell base 51 with the fixing base 52. The driving motor 40 is disposed within the cover 53 and the shaft 41 of the driving motor 40 is passing through the shell base 51 and connected with the axle portion 312 of the driving wheel 31 of the Geneva mechanism 30.

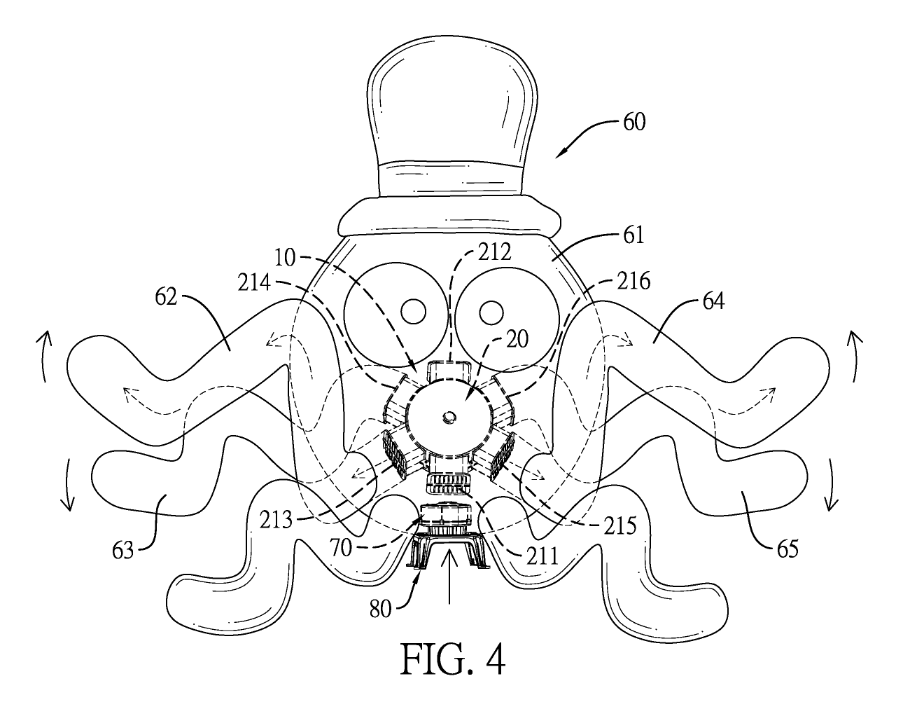

With reference to FIG. 4, the air flow switching apparatus 10 with the six-way valve is used in an inflatable toy 60 and the inflatable toy 60 is an octopus like inflatable toy 60 for an example. The inflatable toy 60 includes a body 61. One side of the body 61 has a first airbag 62 and a second airbag 63, and the other side of the body 61 has a third airbag 64 and a fourth airbag 65. The first airbag 62, the second airbag 63, the third airbag 64, and the fourth airbag 65 of the inflatable toy 60 are used as movable limbs. The inflatable toy 60 also includes a support 80 disposed at bottom of the body 61. An air outlet end of an air pump 70 is located within the body 61. The air pump 70 can be connected with a power source and the air pump 70 can pump air from an exterior of the body 61 to the interior of the body 61 so as to make the inflatable toy form a predetermined three-dimensional shape. The air flow switching apparatus 10 with the six-way valve in the present invention is disposed within the body 61 of the inflatable toy 60. The first opening 213 of the six-way valve 20 is connected with the corresponding first airbag 62 and the second opening 214 of the six-way valve 20 is connected with the corresponding second airbag 63. The third opening 215 is connected with the corresponding third airbag 64 and the fourth opening 216 is connected with the corresponding fourth airbag 65. The exterior end of the air pump 70 is connected with the interior of the body 61 and the inlet 211 of the six-way valve 20 via a pipe. The outlet 212 of the six-way valve 20 is connected with the body 61. The driving motor 40 is connected with the power source, so the driving motor 40 can drive the valve vane 22 within the six-way valve 20 to intermittently rotate via the Geneva mechanism 30.

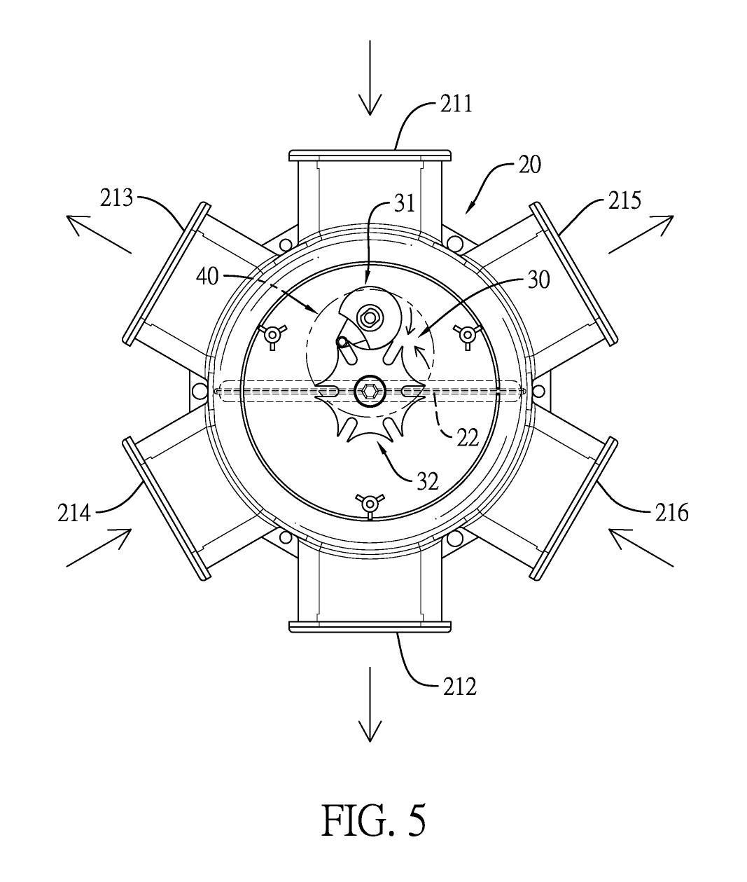

With reference to FIG. 4 and FIG. 5, the valve vane 22 of the six-way valve 20 is located at the alignment chamber 210 and divides the alignment chamber 210 into two spaces to isolate the inlet 211 and the outlet 212 from each other, which are radially corresponding. Therefore, the inlet 211 is connected with the first opening 213 and the third opening 215 through one of the two spaces of the alignment chamber 210 and the outlet 212 is connected with the second opening 213 and the fourth opening 216 through the other space of the alignment chamber 210. Accordingly, after the air pump 70 outputs a portion of air into the body 61 and a portion of air into the inlet 211, the limbs at the first airbag 62 and the third airbag 64 are air pumped in left and right sides of the inflatable toy 60 to generate a rising motion. The air within the limbs at the second airbag 63 and the fourth airbag 65 are passing through the second opening 214 and the fourth opening 216 and air exhausted from the outlet 212 to the body 61 and a drooping motion is generated because of air pressure reduction.

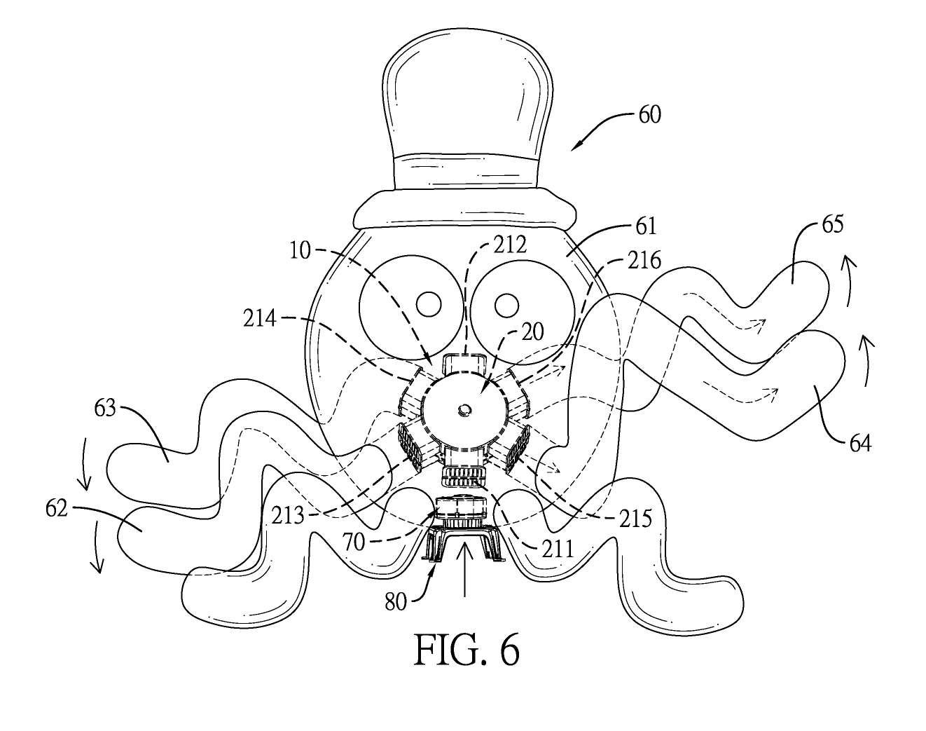

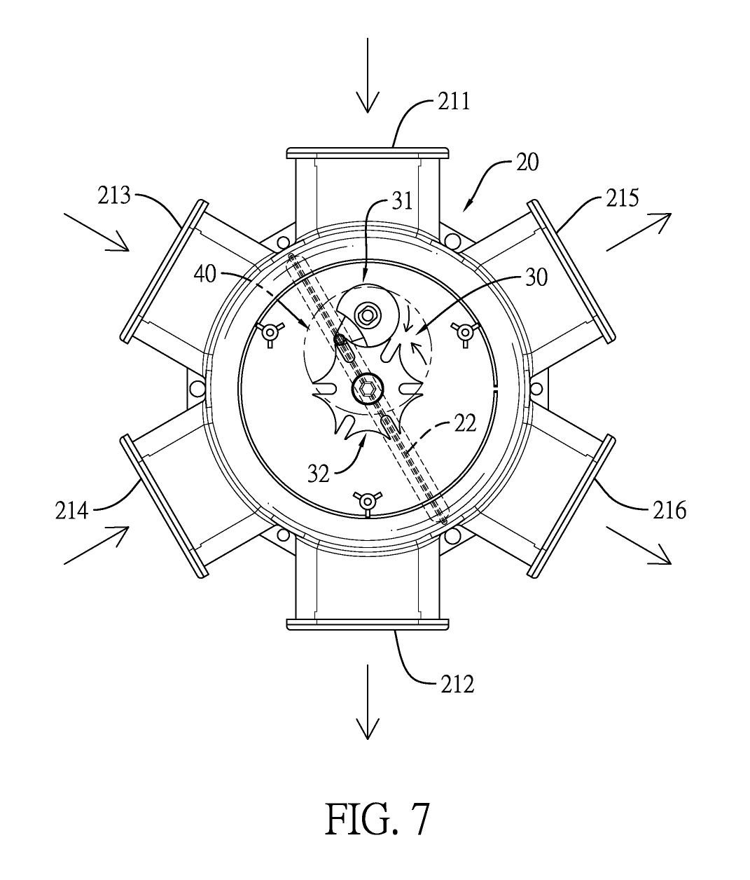

With reference to FIG. 6 and FIG. 7, the driving motor 40 drives the driving wheel 31 within the Geneva mechanism 30 to rotate 360 degrees and the driving motor 40 with the Geneva wheel 32 drives the valve vane 22 within the six-way valve 20 to rotate 60 degrees. Therefore, the six-way valve 20 switches the inlet 211 to be connected with the third opening 215 and the fourth opening 216 and the outlet 212 to connect with the first opening 213 and the second opening 214. At this moment, the air pump 70 pumps air from the inlet 211 to the third opening 215 and the fourth opening 216, and the limbs at the third airbag 64 and the fourth airbag 65 are filled with air to generate the rising motion. The air within the limbs at the first airbag 62 and the second airbag 63 is passing through the first opening 213 and the second opening 214 and released from the outlet 212 to the body 61 so as to generate the lower motion because of the air pressure reduction.

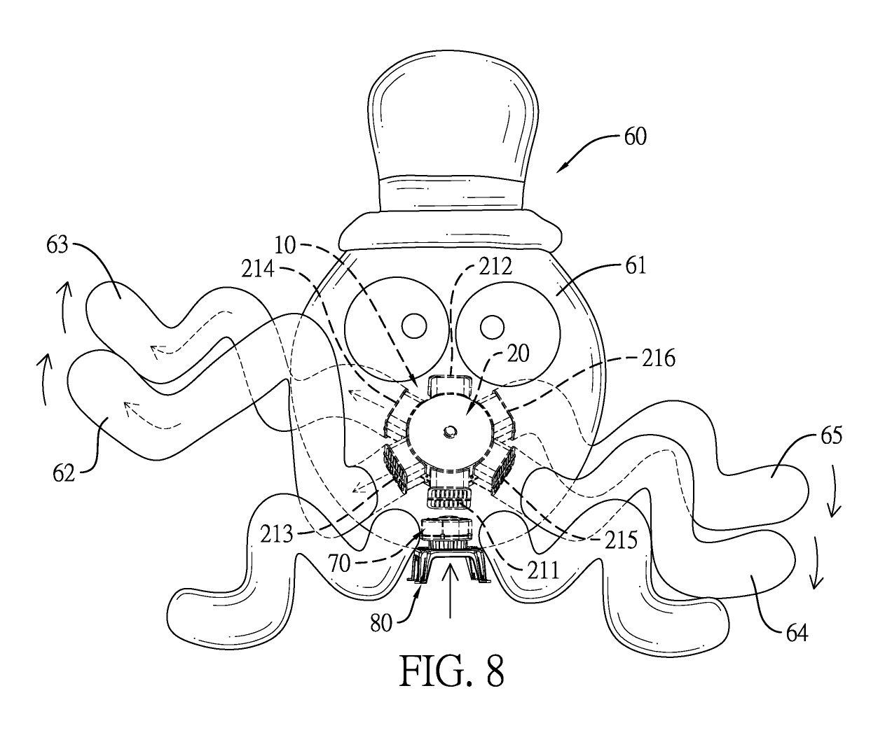

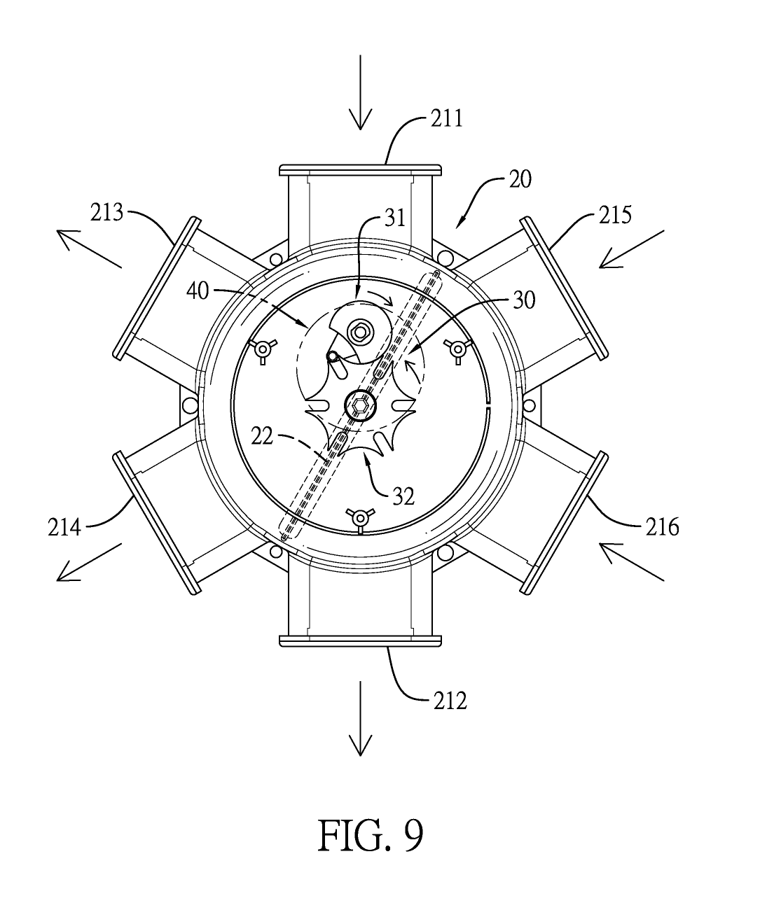

With reference to FIG. 8 and FIG. 9, the driving motor 40 further drives the driving wheel 31 within the Geneva mechanism 30 to rotate 360 degrees and the driving motor 40 with the Genera wheel 32 further drives the valve vane 22 within the six-way valve 20 to rotate 60 degrees. Therefore, the six-way valve 20 switches the inlet 211 to connect with the first opening 213 and the second opening 214 and switches the outlet 212 to connect with the third opening 215 and the fourth opening 216. At this moment, the air pump 70 pumps air from the inlet 211 to the first opening 213 and the second opening 214 and the limbs at the first airbag 62 and the second airbag 63 are filled with air to generate the rising motion. The air within the limbs at the third airbag 64 and the fourth airbag 65 is passing through the third opening 215 and the fourth opening 216 and released from the outlet 212 to the body 61 so as to generate the lower motion because of the air pressure reduction.

The driving motor 40 in the air flow switching apparatus 10 with the six-way valve in the present invention works with the Geneva mechanism 30 to drive the valve vane 22 within the valve 20 to intermittently rotate. The inlet 211 and the outlet 212 of the six-way valve 20 are alternately connected with the first opening 213, the second opening 214, the third opening 215, and the fourth opening 216, so the air flow direction within the inflatable toy 60 is varied via the air flow switching apparatus 10 with the six-way valve. Therefore, the multiple limbs of the inflatable toy 60 generate many different motions by alternately pumping and exhausting the air so as to let the inflatable toy have vivid motion effect.

While the present invention has been described in terms of what are presently considered to be the most practical and preferred embodiments, it is to be understood that the present invention need not be restricted to the disclosed embodiment. On the contrary, it is intended to cover various modifications and similar arrangements included within the spirit and scope of the appended claims which are to be accorded with the broadest interpretation so as to encompass all such modifications and similar structures. Therefore, the above description and illustration should not be taken as limiting the scope of the present invention which is defined by the appended claims.

What is claimed is:

1. An air flow switching apparatus with six-way valve for inflatable toy, comprising:
a six-way valve including:
a valve housing having:
an alignment chamber in a circular shape;
an inlet and an outlet disposed at two sides of the alignment chamber along a radial direction of the alignment chamber and opposite to each other;
a first opening, a second opening, a third opening, a fourth opening, the inlet, and the outlet disposed at a periphery of the valve housing at equiangular intervals and connected with the alignment chamber respectively;
the first opening and the second opening disposed at one side of a centre line from the inlet to the outlet;
the third opening and the fourth opening disposed at the other side of the centre line from the inlet to the outlet; and
a valve vane having:
a length corresponding to a diameter of the alignment chamber; and
a pivot at a middle of the valve vane,
wherein the valve vane is rotatably and pivotally disposed within the alignment chamber and is rotated to switch positions within the alignment chamber to respectively vary a connection relationship of the inlet and the outlet with the first opening, the second opening, the third opening, and the fourth opening;
a Geneva mechanism including:
a driving wheel having:
a circular wheel body;
an axle portion disposed at a centre of the circular wheel body;
an arced notch disposed at one side of the circular wheel body;
a cam portion formed at one end surface of the driving wheel along an axial direction of the driving wheel and radially protruding to the arced notch; and
a guiding rod in a circular shape disposed on the cam portion and at a position where a distance from the cam portion to the axle portion is greater than a radius of the circular wheel body; and
a Geneva wheel disposed outside of the valve housing of the six-way valve and having:
a core wheel portion connected with the pivot of the valve vane;
six guiding units disposed at a periphery of the core wheel portion at equiangular intervals;
six concave arc portions each formed at an exterior edge of a respective one of the six guiding units, respectively corresponding to an exterior contour of the circular wheel body, and selectively sliding to contact the circular wheel body of the driving wheel; and
six guiding grooves respectively disposed along a radial direction of the driving wheel between every two of the adjacent guiding units and configured to be selectively inserted by the guiding rod of the driving wheel; and
a driving motor disposed outside of the valve housing of the six-way valve and having:
a shaft connected with the axle portion of the driving wheel of the Geneva mechanism;
wherein the driving motor drives the valve vane of the six-way valve to alternatively rotate via the Geneva mechanism.

2. The air flow switching apparatus with six-way valve for inflatable toy as claimed in claim 1, wherein the valve housing of the six-way valve comprises two half portions and the two half portions of the valve housing are fastened to each other.

3. The air flow switching apparatus with six-way valve for inflatable toy as claimed in claim 1, wherein the driving motor is disposed outside of the valve housing of the six-way valve via an exterior protective shell, and the exterior protective shell includes:
a shell base fixed at an exterior surface of the valve housing, the Geneva mechanism disposed within the shell base, and the driving motor disposed at an exterior surface of the shell base;
a fixing base; and
a cover fixing the shell base with the fixing base and the driving motor disposed within the cover and the shaft of the driving motor passing through the shell base to be connected with the axle portion of the driving wheel of the Geneva mechanism.

4. The air flow switching apparatus with six-way valve for inflatable toy as claimed in claim 2, wherein
the driving motor is disposed outside of the valve housing of the six-way valve via an exterior protective shell, and the exterior protective shell includes:
a shell base fixed at an exterior surface of the valve housing, the Geneva mechanism disposed within the shell base, and the driving motor disposed at an exterior surface of the shell base;
a fixing base; and
a cover fixing the shell base with the fixing base and the driving motor disposed within the cover and the shaft of the driving motor passing through the shell base to be connected with the axle portion of the driving wheel of the Geneva mechanism.
